(19) United States
(12) Patent Application Publication
(10) Pub. No.: US 2024/0270643 A1
(43) Pub. Date: Aug. 15, 2024

(54) WASTE PLASTIC CONVERSION

(71) Applicant: Jonathan Cook, Statesboro, GA (US)

(72) Inventor: Jonathan Cook, Statesboro, GA (US)

(21) Appl. No.: 18/644,681

(22) Filed: Apr. 24, 2024

Related U.S. Application Data
(63) Continuation-in-part of application No. 16/842,984, filed on Apr. 8, 2020, now Pat. No. 11,993,540.
(60) Provisional application No. 62/831,282, filed on Apr. 9, 2019.
(60) Provisional application No. 62/831,292, filed on Apr. 9, 2019.

(51) Int. Cl. C04B 18/20; C04B 7/02; C04B 14/02; C04B 14/06; C08J 11/06

(52) U.S. Cl. CPC C04B 18/20; C04B 7/02; C04B 14/022; C04B 14/06; C08J 11/06; C08J 2367/02

(57) ABSTRACT

Waste plastic can be converted into rock for decorative and utilitarian applications. A combination of sand and waste plastic is added into a tumbling chamber, and the tumbling chamber is rotated. The combination of sand and waste plastic is heated while rotating the tumbling chamber, and when the combination of sand and waste plastic reaches a predetermined temperature, a mixture of glass and a carbon-based material is added. Conglomerates begin to form with increasing temperatures, and when a desired size of the conglomerates is achieved, heating is discontinued. A slurry coating is added to the tumbling chamber while continuing to rotate the tumbling chamber.

### CROSS-REFERENCES TO RELATED APPLICATIONS

This application is a continuation-in-part of U.S. patent application Ser. No. 16/842,984, pending, which claims the benefit of U.S. Provisional Patent Application No. 62/831,282, filed Apr. 9, 2019, and U.S. Provisional Patent Application No. 62/831,292, filed Apr. 9, 2019, the entire contents of each of which are herein incorporated by reference.

### STATEMENT REGARDING FEDERALLY SPONSORED RESEARCH OR DEVELOPMENT

(NOT APPLICABLE)

### BACKGROUND

The invention relates to processing recyclable materials and, more particularly, to a barrel shredder used to process recyclable plastic and a waste plastic conversion machine and process for recyclable plastics.

Plastics are inexpensive and durable materials, which can be used to manufacture a variety of products that find use in a wide range of applications. The production and use of plastics have increased dramatically over the last decades. About 40% of these plastics are used for single-use disposable applications, such as packaging, agricultural films, disposable consumer items or for short-lived products that are discarded within a year of manufacture. Because of the durability of the polymers involved, substantial quantities of plastics are piling up in landfill sites and in natural habitats worldwide, generating increasing environmental problems. Even degradable and biodegradable plastics may persist for decades depending on local environmental factors such as levels of ultraviolet light exposure, temperature, presence of suitable microorganisms, etc.

One solution to reduce environmental and economic impacts correlated to the accumulation of plastic is closed-loop recycling, where plastic material is mechanically reprocessed to manufacture new products. For example, one of the most common closed-loop recycling processes is the polyethylene terephthalate (PET) recycling. PET wastes are subjected to successive treatments leading to food-contact-approved recycled PET (rPET), which is collected, sorted, pressed into bales, crushed, washed, chopped into flakes, melted and extruded in pellets and offered for sale. Then, these recycled PET may be used to create fabrics for the clothing industry or new packaging such as bottles or blister packs, etc.

Plastic wastes, however, are generally collected all together, so that plastic bales contain a mixture of different plastics, the composition of which may vary from source to source, and the proportions of which may vary from bale to bale. Consequently, recycling processes require preliminary selection to sort out the plastic products according to their composition, size, resin type, color, functional additives used, etc.

### SUMMARY

It would thus be desirable for a plastic recycling process that can convert recyclable plastics into useful new products. It would also be desirable for this process to utilize different plastics, eliminating the need for preliminary selection practices.

A barrel shredder may be used to process recyclable plastic. The barrel shredder is a low-cost machine designed for shredding plastic, paper, and other “soft” materials, as well as pulverizing glass waste to create glass “sand.” As designed, the shredder is suitable for small scale waste management and recycling organizations but can be scaled up to meet the demand for greater volume.

For optimum processing, it is desirable that the plastic be rigid/semi-rigid, less than or equal to 0.25 inches wall thickness, and limited in overall size to accommodate the opening to the shred chamber. Glass should be untempered, less than or equal to 0.75 inches wall thickness, and limited in overall size to accommodate the opening to the shred chamber.

A waste plastic conversion machine and process are designed to be simple and low-cost/high-volume for converting waste plastic into “rock” for use in decorative and utilitarian applications, such as non-structural concrete. The term “waste plastic” refers to most consumer plastic packaging, utilitarian items, and decorative items. The word “rock” is defined as a small, hard, conglomeration of glass powder or sand and fused plastic.

In an exemplary embodiment a method of converting waste plastic into rock for decorative and utilitarian applications includes the steps of (a) adding a combination of sand and waste plastic into a tumbling chamber; (b) rotating the tumbling chamber; (c) heating the combination of sand and waste plastic while performing step (b); (d) when the combination of sand and waste plastic reaches a predetermined temperature, adding a mixture of glass and a carbon-based material while performing step (b); (e) increasing the temperature until conglomerates begin to form while performing step (b); (f) when a desired size of the conglomerates is achieved, discontinuing the heating; and (g) adding a slurry coating to the tumbling chamber while continuing to rotate the tumbling chamber.

Step (d) may be practiced such that the predetermined temperature is approximately 285° F.

In some embodiments, the carbon-based material in step (d) may comprise biochar, or activated carbon, or a mixture of biochar and activated carbon. A particle size of the carbon-based material may be less than or equal to #150 mesh. Step (d) may be practiced such that a mix ratio is 15-20 percent powder by weight.

Step (d) may be practiced by adding the mixture of glass and carbon-based material incrementally while maintaining an average temperature between 285-300° F. In this context, step (d) may be further practiced by adding the mixture of glass and carbon-based material at a mix ratio of at least ten percent carbon powder by weight.

The method may further include, prior to step (f), when the temperature reaches a final temperature, holding the final temperature for at least five minutes while continuing to rotate the tumbling chamber. After holding the final temperature for the at least five minutes, cooling the conglomerates prior to step (g). The cooling step may be practiced by cooling the conglomerates to 100-105° F.

In some embodiments, the slurry coating in step (g) may include one part cement and one part biochar, or activated carbon, or a combination of biochar and activated carbon. The cement in the slurry coating in step (g) may be Portland cement.

In another exemplary embodiment, waste plastic is converted into rock for decorative and utilitarian applications using a waste plastic conversion machine including a tumbling chamber and at least one heat source positionable adjacent the tumbling chamber. The method includes the steps of (a) adding a combination of sand and waste plastic into the tumbling chamber; (b) rotating the tumbling chamber; (c) heating the combination of sand and waste plastic with the heat source while performing step (b); (d) incrementally adding a mixture of glass and a carbon-based material to the combination of sand and waste plastic while performing step (b) to form conglomerates; (e) cooling the conglomerates; and (f) adding a slurry coating to the tumbling chamber while continuing to rotate the tumbling chamber.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other aspects and advantages will be described in detail with reference to the accompanying drawings, in which:

FIG. 1 shows a barrel shredder suitable for processing recyclable plastic;

FIG. 2 shows a waste plastic conversion machine;

FIG. 3 is a color image showing examples of the final product in various colors;

FIGS. 4A-4G show a modified barrel shredder; and

FIG. 5 shows a modified tumbler.

### DETAILED DESCRIPTION

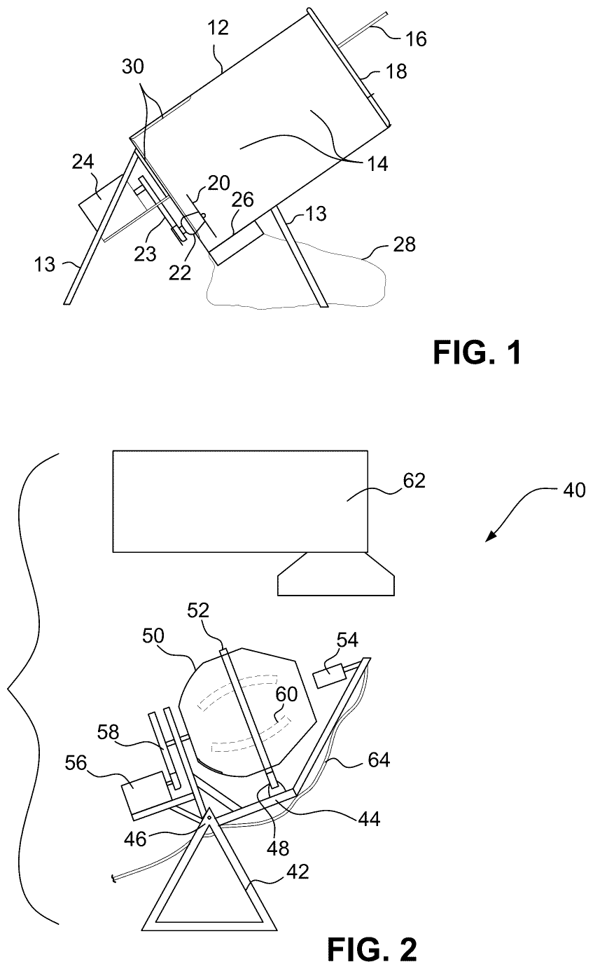

FIG. 1 shows a barrel shredder for processing recyclable plastic. A barrel 12 is supported on supports 13 or the like. In use, material to be shredded enters the barrel 12 and into the shred chamber 14 by lifting the lid 16 and inserting material through the opening 18. This occurs while the machine is running. Once in the chamber, a blade 20 cuts the material into the desired size. The blade 20 as designed may rotate in a counter-clockwise direction at approximately 3600 rpm. In some embodiments, the blade 20 is 14″ in length, sharpened on the leading edge, and has a down-turned trailing edge to help draw material into the blade 20 (for glass applications, the sharpened leading edge is replaced with a blunt carbide edge). The blade 20 is mounted on a spindle 22, which is belt driven via a drive belt 23 and powered by a 5 HP electric motor 24. At the base of the machine, a rectangular perforated steel discharge plate 26 is mounted. The blade 20 and the discharge plate 26 are interchangeable with other blade types or discharge plate sizes in order to quickly change the material being processed. The openings in the perforated steel discharge plate 26 measure between 0.063″ up to 0.5″ depending on the desired final size of material.

The material is continually fed into the machine and processed by the rotating blade 20 until its size is small enough to allow for discharge through the discharge plate 26 into the attached collection bag 28.

The machine also has wear plates 30 mounted to the bottom and lower sides of the barrel enclosure. An exemplary material used for the wear plates 30 is 0.25″ thick UHMWPE (Ultra High Molecular Weight Polyethylene).

FIG. 2 shows a waste plastic conversion machine 40. The machine 40 is configured to further process the material from the barrel shredder into a finished product. With reference to FIG. 2, the machine 40 includes a base frame 42, a supporting bracket 44 secured to the base frame 40 on a pivot 46, a trunnion wheel 48 secured on the supporting bracket 44, and a tumbling chamber 50 including a trunnion ring 52. The tumbling chamber 50 is rotatably supported by the supporting bracket 44 with the trunnion ring 52 engaging the trunnion wheel 48. The pivot 46 allows for the chamber 50 to be emptied. A heat source 54 is secured on the supporting bracket 44 and is positionable adjacent the tumbling chamber 50. A motor 56 is connected to the tumbling chamber 50 via a drive gear 58. The motor 56 is configured to rotate the tumbling chamber 50 via the drive gear 58. The tumbling chamber 50 may be provided with internal mixing vanes 60.

A VOC (Volatile Organic Compound) air scrubber 62 serves to evacuate the exhaust gasses emitted from the tumbling chamber 50. The VOC air scrubber 62 is existing technology, and details thereof will not be further described. The VOC air scrubber is important for the safe operation of the machine 40.

The heat source 54 may be a propane torch head or the like positioned adjacent an opening in the tumbling chamber 50. A fuel line 64 delivers fuel to the torch head 54.

In use, a combination of sand and shredded plastic is added to the tumbling chamber 50 where it is rotated by the motor 56, mixed by the internal mixing vanes 60 and heated by the torch head 54. In some embodiments, the tumbling chamber 50 rotates in a counter-clockwise direction at 36 RPM. As designed, it is powered by a ½ HP electric motor 56 turning at 1075 RPM, which utilizes a gear reduction system via drive gear 58 to produce the necessary RPM. The torch head 54 may be rated for 60,000 BTUs at full power and burns propane gas as designed. The torch head 54 is also mounted on a cantilever arm as shown so it can be moved out of the way for emptying the contents of the chamber 50.

The size of the processed “rock” can be varied from as small as 0.063″ in diameter up to greater than 12″ in diameter. The finish of the “rock” can be varied from rough to semi-smooth, and the style can vary from a similarity with crushed granite to a similarity with river rock. The color of the rock can be varied indefinitely. Waste plastic does not have to be washed or exactly separated in this process. In addition, labels and closures do not have to be removed.

The following process describes creating ½ cubic feet of river rock style material. The process begins with twelve pounds of shredded waste plastic with the approximate size of ½″ diameter flakes. The mixture shall be approximately 35% PET/PETE/PETT, 35% HDPE/PP, and 30% various other types. This mixture can be varied to alter the ultimate properties and size of the final product. The plastic mix may contain labels, closures, content residue, and other miscellaneous contaminants at a rate of less than approximately 5% total weight. However, more contamination is acceptable and does not dramatically alter the process.

The twelve pounds of plastic are combined with sixteen pounds of fine sand (masonry sand) or glass powder (equivalent in size to masonry sand) (ratio of 1 pound plastic to 1.25 pounds sand/powder) in the tumbling chamber 50 of the waste plastic conversion machine 40. The machine 40 is turned on, and heat is added from the propane torch 54. The torch 54 is operated at a level to raise the temperature of the tumbling material approximately 50° F. per minute until the contents reach approximately 325° F. At this point, the air scrubber 62 begins evacuating the exhaust gasses emitted from the tumbling chamber 50, and the temperature is held constant as the mixture begins to conglomerate. As conglomerates are formed, the conglomerates are visually observed for size. If a larger size is desired, the temperature may be increased to approximately 350-375° F. When the final desired size is achieved, the torch 54 is turned off completely, and the material is allowed to tumble for approximately two minutes in order to smooth the surface.

Then, approximately three pounds of dry cement is added at the rate of one pound per ten seconds. The cement can be colored with a dry colorant to vary the shade of the rock. The material is then allowed to tumble freely, which allows the cement to embed itself into the surface of the softened material. The material tumbles until the surface temperature reaches 250° F. or less. At this point, the material is hard enough to retain its shape and can be emptied from the machine 40.

This process can be shortened in time (temperature raised faster and/or cutting out the smoothing phase) in order to produce an aggregate suitable for non-structural concrete. In this case, the cement used may be a typical Portland cement, which allows for complete bonding within the mixture of concrete. The “rock” produced is approximately 50% lighter than crushed granite which, when used as a substitute to crushed granite, produces a final concrete mix approximately 30% lighter than a typical crushed granite mix.

Plastic film can also be converted to the “rock” using a similar method. To make a similar volume, approximately 25 pounds of sand is loaded into the conversion machine and preheated to approximately 350° F. Plastic bags and other film are then added at a rate where the sand evenly coats the plastic as it is added. The heat from the torch 54 is set to a level that maintains the ambient temperature of the tumbler 50 above 300° F. Once the tumbler 50 is fully loaded, the mix is allowed to tumble at a temperature of approximately 325° F. until the plastic rock is fully formed. The mix is then allowed to cool as it tumbles until the surface temperature of the rocks are at or below 250° F. The mix is then emptied into a vibratory sift where the excess sand is removed leaving only the formed plastic rocks.

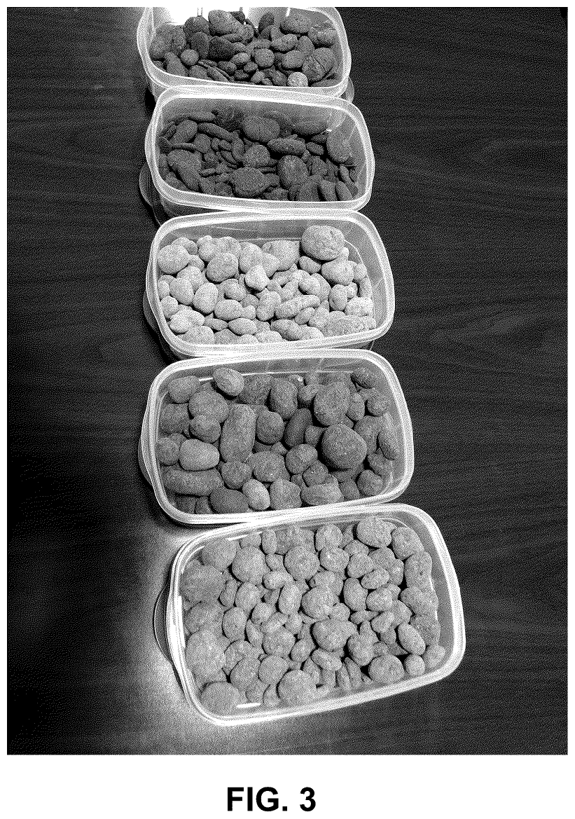

FIG. 3 is a color image showing examples of the final product in various colors. As noted, the color of the rocks can be varied indefinitely.

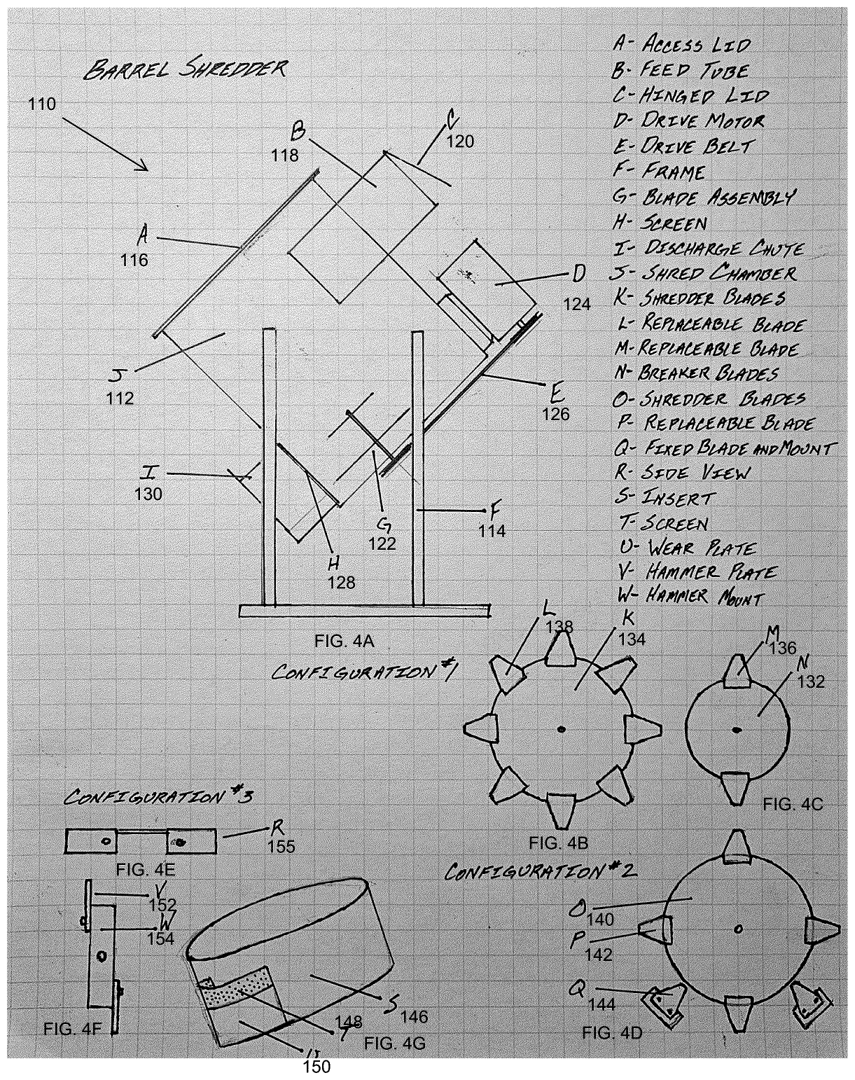

A modified barrel shredder 110 is shown in FIGS. 4A-4G. The modified barrel shredder has been improved in two significant ways: 1) The addition of the feed tube allows for a more contained shredding chamber. Material can be added constantly as material is shredded and ejected without releasing dust or particles. 2) The general purpose shredding blade assembly has been redesigned for greater efficiency and utilizes “off the shelf” blades that are longer lasting, less expensive, and easy to maintain.

With reference to FIG. 4A, a shred chamber 112 is supported on a frame 114. The shred chamber 112 includes an access lid 116 and a feed tube 118 with a hinged lid 120. A rotatable blade assembly 122 is secured at a bottom of the shred chamber 112 and is coupled with a drive motor 124 via a drive belt 126. The shred chamber also includes a screen 128 and a discharge chute 130.

The barrel shredder 110 has three main configurations. The first configuration shown in FIGS. 4B and 4C is a general purpose configuration. This can be used to shred rigid and non-rigid plastics, elastic and non-elastic plastic films, open or closed cell polystyrene (commonly referred to as Styrofoam), paper, cardboard, aluminum cans, steel or tin cans, or any other material that are considered “soft” materials in the industry. The second configuration shown in FIG. 4D is used primarily for shredding plastic films. The third configuration shown in FIGS. 4E-4G is used for pulverizing glass, ceramics, or other mineral-based items.

With reference to FIGS. 4B and 4C, the first configuration uses a two-stage blade assembly. The first stage is the breaker blade 132 situated approximately two inches above the shredder blade 134. The breaker blade 132 includes replaceable teeth 136 (two shown), and the shredder blade 134 includes replaceable teeth 138 (eight shown). The breaker blade 132 begins breaking down larger items into smaller pieces. The second stage is the shredder blade 134 that further breaks down the pieces until the desired size is achieved. The desired size is achieved by changing the ejection screen 128 with a screen that has either larger or smaller openings.

With reference to FIG. 4D, the second configuration uses a single stage blade assembly with a fixed shear blade 140 including replaceable teeth 142 (four shown) and a fixed blade 144 and mount. The fixed blade 144 is a removable, single bevel, hardened tool steel blade which acts as a counter shear for the rotating blades. This blade is attached to a solid mount affixed to the machine. This blade assembly is known.

With reference to FIGS. 4E-4G, the third configuration uses a single stage hammer assembly with the addition of a hardened steel liner for the chamber. A hardened steel insert 146 lines the bottom of the shred chamber 112 when in the third configuration. A perforated steel screen 148 that is interchangeable determines the particle size of pulverized material by the size of the holes in the screen 148. The configuration also includes an interchangeable wear plate 150. FIG. 4F shows an interchangeable abrasion resistant steel hammer plate 152 and a hammer mount 154.

The hammer plate 152 and the hammer mount 154 are used to pulverize glass. The assembly includes the reusable hammer mounting plate 154 and abrasive resistant steel hammers 155. In an exemplary construction, the steel hammers 155 are two inches by four inches in size made from one-half inch AR500 steel and are mounted using a single one-half inch grade 8 bolt. These hammers wear down with use, so can be replaced as needed.

FIG. 4G shows the insert used when the machine processes glass or other hardened mineral-based materials (e.g., natural rocks, concrete fragments, ceramic fragments). In an exemplary construction, the abrasive resistant steel insert/liner 146 is made from ⅛″ AR500 steel. The liner 146 protects the inside wall of the machine from the abrasive properties of the material being processed and is replaceable as needed.

The main wear plate 150 is a bolt-in replaceable section of the liner 146. This wear plate 150 is situated where most of the abrasive action of the materials occurs and is intended to be replaced periodically as a function of routine maintenance.

The screen 148 is used to determine the desired size of particles being ejected from the machine. In an exemplary construction, the screen 148 is made from a perforated steel sheet with typically between 1/16″-⅛″ hole openings. These openings may be larger or smaller depending on the desired particle size. The screen 148 is situated above the wear plate 150 and is therefore not subjected to as much wear as the rest of the insert.

An important distinction of the barrel shredder 110 is that it can be made scalable in both size and power requirements. The basic machine uses a standard 110-120 volt AC “household current” electric motor. However, the machine can be scaled up to use a 220-240 volt AC, or a three-phase motor. Additionally, it can be scaled down to use smaller 12-volt DC motor or operated remotely using an internal combustion engine. Another key distinction is the ability to shred plastics that range widely in thickness. Most shredders are designed with narrow parameters limiting either the thickness of the material to be shredded or the overall size of the material to be shredded. The barrel shredder 110 of the described embodiments has vastly larger parameters and can shred most post-consumer plastic packaging without issue. A final distinction is that a single machine can be used for any of the three configurations.

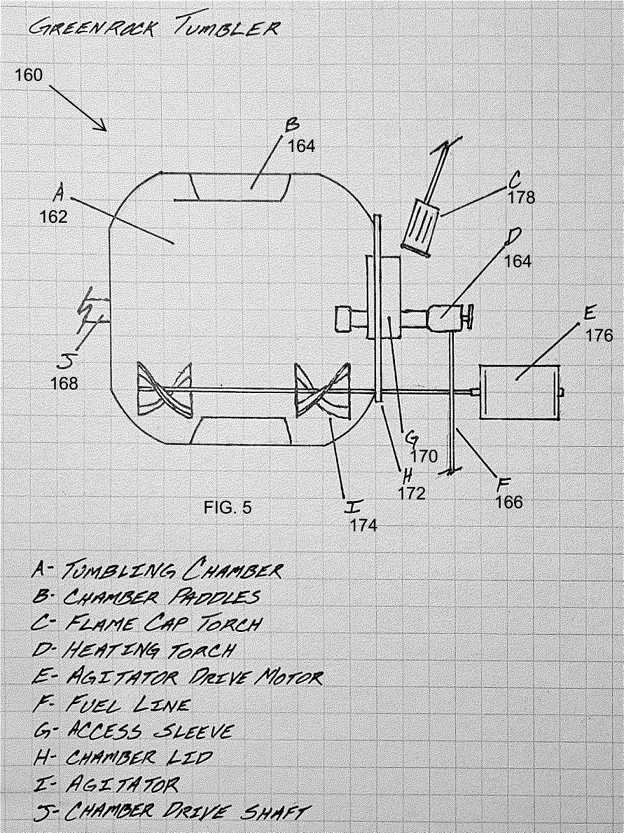

A modified tumbling machine 160 is shown in FIG. 5. Many of the components are similar to the first embodiment including the tumbling chamber 162, mixing vanes/chamber paddles 162, a first heat source 164, and a fuel line 166 (e.g., a propane fuel line). A chamber drive shaft 168 is shown on the left side of the image and connects to a tumbler drive assembly. The chamber paddles 162 are affixed to the chamber walls and function to mix materials. The first heat source 164 is preferably a forge-style propane torch and functions to heat the materials.

An access sleeve 170 is a fixed position sleeve and functions to allow access for the first heat source 164 as well as temperature readings using an infrared thermometer. A chamber lid 172 is in a fixed position and functions to seal the tumbling chamber 162.

The updated tumbling machine 160 has a few distinctions. One distinction is the rotating agitator 174 driven by a fixed position agitator drive motor 176. In some embodiments, the agitator 174 is a screw-type agitator with a right-hand twist at one end and a left-hand twist at the other end. The agitator is in a fixed position rotating at 400-600 rpms (depending on the size of the machine)

The agitator 174 is designed to both pull material from the back of the tumbling chamber 162 towards the front and push material from the front of the tumbling chamber 162 towards the back. Additionally, the agitator 174 breaks apart larger conglomerations as they form resulting in a more consistently sized final product.

Another distinction is the addition of a second heat source 178. This second heat source or torch 178 provides a “flame cap” that serves to prevent oxygen from reaching the tumbling chamber 162 and to combust any exhaust gases that may be released by the material during the process. In some embodiments, the second heat source 178 utilizes a low pressure propane flame.

In use, the tumbling chamber is rotated at approximately 12 rpm.

A variation in the manufacturing process uses the same basic method described above. Waste plastics of all types are shredded without the need of cleaning or sorting into specific types. They are then added to the aggregate-making tumbling machine and are heated with an external heat source. The machine tumbles, constantly mixes, and heats the shredded plastic. When the material reaches a temperature of approximately 285° F., a mixture of glass and a carbon-based product such as biochar begins to be added. This mixture consists of post-consumer glass powder (or other similar mineral powder) that has a particle size less than or equal to #150 mesh, combined with biochar, or activated carbon, or a combination of both with a particle size less than or equal to #150 mesh, at a mix ratio of at least ten percent carbon powder material by weight. This powdered mixture is added incrementally while maintaining an average temperature between 285-300° F. (temperature may be monitored using an infrared thermometer). This powdered mixture is incorporated thoroughly into the shredded plastic during this process.

The aggregate begins forming at approximately 285° F. and continues forming as the temperature is increased to a temperature between 325-350° F. Ultimately, the amount of powdered mixture added will be a ratio of approximately 15-20 percent powder by weight. When the material reaches the final temperature, it is held at this temperature for at least five minutes as it continues to tumble and mix. The material is then allowed to cool as it continues to tumble. Water can be added to speed the cooling.

When the material cools to a temperature of 100-105° F., a slurry coating is added. This slurry coating consists of approximately one part cement, preferably Portland cement, to one part biochar, or activated charcoal, or a combination of both by volume. The amount of slurry may vary depending on the desired finish of the aggregate.

The addition of biochar, or activated charcoal, or a combination has two important functions. First, this carbon material will adsorb chemicals or gases that may be released if the plastics used to make the aggregate begin to degrade. Secondly, the carbon material used is sequestered carbon, and because the amount of sequestered carbon used is greater than the amount of carbon produced in the process, the aggregate can be described as being carbon negative.

One of the important distinctions in the modified process is the ability to use a mixture of all types of plastics. It is estimated that there are over 3,000 different polymers and copolymers of plastics. Most traditional recycling processes use a single type of plastic, while the described process is able to incorporate all of the more than 3,000 different types of plastics. Another distinction is that traditional recycling processes require the plastic material to be clean, while cleaning is not necessary in the described process. That is, cleaning is not necessary for several reasons. The heat used in the process sterilizes the waste plastic, the carbon used in the process acts to adsorb any remnant chemical contaminate, and the residue left on the plastic that would need to be cleaned for a traditional recycling process does not interfere with the polymer binding that occurs in this process as the plastic is heated. Still further, there are no filter screens the heated plastic must pass through as is typical in traditional recycling processes. Yet another distinction is that traditional recycling produces items that have a limited lifespan (estimated to be an average of 2-4 years) while the lifespan of the aggregate manufactured using the described process is indefinite. A final distinction is that traditional recycling requires an industrial scale of operation while the described process is scalable and can be used at a small “hobby-scale” level all the way up to industrial scale.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of converting waste plastic into rock for decorative and utilitarian applications, the method comprising:
(a) adding a combination of sand and waste plastic into a tumbling chamber;
(b) rotating the tumbling chamber;
(c) heating the combination of sand and waste plastic while performing step (b);
(d) when the combination of sand and waste plastic reaches a predetermined temperature, adding a mixture of glass and a carbon-based material while performing step (b);
(e) increasing the temperature until conglomerates begin to form while performing step (b);
(f) when a desired size of the conglomerates is achieved, discontinuing the heating; and
(g) adding a slurry coating to the tumbling chamber while continuing to rotate the tumbling chamber.

2. A method according to claim 1, wherein step (d) is practiced such that the predetermined temperature is approximately 285° F.

3. A method according to claim 1, wherein the carbon-based material in step (d) comprises biochar, or activated carbon, or a mixture of biochar and activated carbon.

4. A method according to claim 3, wherein a particle size of the carbon-based material is less than or equal to #150 mesh.

5. A method according to claim 3, wherein step (d) is practiced such that a mix ratio is 15-20 percent powder by weight.

6. A method according to claim 1, wherein step (d) is practiced by adding the mixture of glass and carbon-based material incrementally while maintaining an average temperature between 285-300° F.

7. A method according to claim 6, wherein step (d) is further practiced by adding the mixture of glass and carbon-based material at a mix ratio of at least ten percent carbon powder by weight.

8. A method according to claim 1, further comprising, prior to step (f), when the temperature reaches a final temperature, holding the final temperature for at least five minutes while continuing to rotate the tumbling chamber.

9. A method according to claim 8, further comprising, after holding the final temperature for the at least five minutes, cooling the conglomerates prior to step (g).

10. A method according to claim 9, wherein the cooling step is practiced by cooling the conglomerates to 100-105° F.

11. A method according to claim 1, wherein the slurry coating in step (g) comprises one part cement and one part biochar, or activated carbon, or a combination of biochar and activated carbon.

12. A method according to claim 11, wherein the cement in the slurry coating in step (g) comprises Portland cement.

13. A method of converting waste plastic into rock for decorative and utilitarian applications using a waste plastic conversion machine including a tumbling chamber and at least one heat source positionable adjacent the tumbling chamber, the method comprising:
(a) adding a combination of sand and waste plastic into the tumbling chamber;
(b) rotating the tumbling chamber;
(c) heating the combination of sand and waste plastic with the heat source while performing step (b);
(d) incrementally adding a mixture of glass and a carbon-based material to the combination of sand and waste plastic while performing step (b) to form conglomerates;
(e) cooling the conglomerates; and
(f) adding a slurry coating to the tumbling chamber while continuing to rotate the tumbling chamber.

14. A method according to claim 13, wherein the carbon-based material in step (d) comprises biochar, or activated carbon, or a mixture of biochar and activated carbon.

15. A method according to claim 14, wherein a particle size of the carbon-based material is less than or equal to #150 mesh.

16. A method according to claim 12, wherein the slurry coating in step (f) comprises one part cement and one part biochar, or activated carbon, or a combination of biochar and activated carbon.
